(19) United States
(12) Patent Application Publication
(10) Pub. No.: US 2025/0059447 A1
(43) Pub. Date: Feb. 20, 2025

(54) PROCESS OF DEHALOGENATION OF PLASTIC MATERIALS INCLUDING RECYCLED ONES, AND USE OF ONE OR MORE CHEMICAL COMPOUNDS CONTAINING NITROGEN AS A DEHALOGENATING AGENT OF PLASTIC MATERIALS INCLUDING RECYCLED ONES

(71) Applicants: ENI S.P.A., Roma (RM) (IT); VERSALIS S.P.A., San Donato Milanese (MI) (IT)

(72) Inventors: Francesco SCAVELLO, Mantova (MN) (IT); Daniele BALDUCCI, San Donato Milanese (MI) (IT); Erica MONTANARI, San Donato Milanese (MI) (IT)

(21) Appl. No.: 18/721,510

(22) PCT Filed: Dec. 19, 2022
(86) PCT No.: PCT/IB2022/062477

§ 371 Date: Jun. 18, 2024

(30) Foreign Application Priority Data
Dec. 21, 2021 (IT) 102021000031964

(51) Int. Cl. C10G 1/06; B01J 23/28; B29B 7/48; B29B 7/82; B29B 7/84; B29B 7/86

(52) U.S. Cl. CPC C10G 1/06; B01J 23/28; B29B 7/484; B29B 7/82; B29B 7/845; B29B 7/86

(57) ABSTRACT

A process involving the dehalogenation of plastic materials, or mixtures of plastic materials, including recycled ones, containing halogenated components is described, wherein during the heating to 150° C.-450° C. of the material to be treated, a dehalogenating agent containing nitrogen is added in such a quantity that the ratio between the moles of nitrogen of the dehalogenating agent and the sum of the moles of halogen contained in the plastic material is at least 1:1.

### CROSS-REFERENCE TO RELATED APPLICATIONS

This application is a 35 U.S.C. § 371 National Stage patent application of PCT/IB2022/062477, filed on 19 Dec. 2022, which claims the benefit of Italian patent application 102021000031964, filed on 21 Dec. 2021, the disclosures of which are incorporated herein by reference in their entirety.

### TECHNICAL FIELD

The present disclosure relates to the treatment of plastic materials intended to be used in the chemical recycling processes for the valorization of plastic materials otherwise destined for disposal in landfills or waste-to-energy.

The present disclosure specifically relates to a process for treating plastic materials or mixtures of different plastic materials, including recycled ones, containing halogenated components to obtain a final composition of plastic material or plastic materials having a decreased, i.e. lower, halogen content with respect to the material to be treated.

### BACKGROUND

The processes used in the art to make a polymeric material returned to its original state, as a monomer or as a precursor, are various and can be summarised in pyrolysis processes of plastic waste which are transformed into synthetic oils from which to obtain monomers again and in chemical processes of plastics depolymerisation.

An important aspect of the treatment processes for the recycling of the polymeric material is the decrease of the chlorine content, especially when the material to be recycled is a mixture of plastics deriving from different types of polymers.

Chlorine is in fact inconvenient because when burned it can give rise to dioxins which are highly toxic, or to hydrogen chloride which is a strongly caustic gas on the mucous membranes, as well as highly corrosive in contact with materials including water.

The processes known to treat waste/recycle materials, such as RDF (solid fuel), to reduce the chlorine content present in it generally involve the heat treatment of the solid material and subsequently the neutralization of the gaseous chlorine-based compounds, or the mixing of the solid material with reactive solid compounds capable of forming stable chlorides during the heating of the material, or the pyrolysis of the plastic material and dechlorination of the product obtained.

JPH1119617 A describes a method to eliminate chlorine in solid fuels (RDF), also deriving from municipal waste such as plastics, by feeding the RDF and the agent to eliminate chlorine in an equipment where the RDF is mixed and crushed, followed by a heat treatment and washing to remove the formed chlorides, e.g. sodium chloride. The dechlorinating substance is in fact a compound of an alkaline metal, specifically an hydroxide or a carbonate thereof, more specifically sodium and potassium hydroxide or carbonate.

JPH10235186A discloses a dechlorination process of waste materials, e.g., plastics, or industrial processes where the carbonate is put in contact with a chlorine-based gas which has been generated by the thermal treatment of municipal waste and which has to be removed. The contact can be made with a solution or suspension of the carbonate powder or by using another method.

JPH10235309A discloses a method to prevent the production of hydrochloric acid during the thermal treatment of plastics, which involves the feeding during the heat treatment of a dechlorinating agent, such as sodium bicarbonate, which reacts with hydrogen chloride to form sodium chloride, water and carbon dioxide, thus preventing the formation of dioxins.

JPH11199703A discloses a two-step treatment method of waste plastic to almost completely remove chlorine, which involves a first heating to 250-300° C. for the removal of hydrogen chloride. The plastic is then ground and treated in a second reactor, where sodium hydroxide, sodium carbonate or a mixture of the two is used as reactive agent, at a temperature of 300-330° C., thus removing the remaining chlorine as sodium chloride.

JPH1121573A discloses a process of dechlorination of RDF which involves the treatment of RDF at a temperature of between 20° and 1000° C. and the contact with a dechlorinating agent such as sodium bicarbonate, sodium hydroxide, potassium carbonate and similar agents.

CN1219581C describes the use of a dechlorinating agent suitable for high temperatures to remove hydrochloric acid from natural gas, naphtha, syngas for ammonia production, and hydrogen, where this agent is a solid such as calcium oxide or calcium hydroxide in powder or paste, or precipitated calcium carbonate.

JP 2001 270962A describes a method of dechlorination of plastic material by mechanical action in the presence of a powder of inorganic material which generates a dechlorinated resin. The resin containing chlorine is in fact ground and mixed with a hydroxide or a carbonate of an alkaline metal: the mixture is converted into a mixture of dechlorinated resin and a chloride of an alkaline metal by applying mechanical energy, such as compression force, shear force, impact force, friction force and similar forces. For example, a ball mill can be used. The treated mixture is washed with water so as to remove the alkali metal chloride. Preferably, the chlorine-containing resin is PVC and the alkali metal is sodium or potassium, such as sodium hydroxide, potassium hydroxide, sodium carbonate and potassium carbonate. The removal can be done by washing with water, because during the mechanical treatment the chlorine is transferred into an inorganic powder. The time of application of mechanical energy is from 15 to 3000 minutes.

WO2018/025103 discloses a process of dechlorination of oils which derive from the pyrolysis of a plastics mixture (plastic waste) and are intended for the steam cracker, wherein a zeolite catalyst is introduced together with the oil having a chlorine content greater than 10 ppm and optionally a stripping gas, e.g. nitrogen, C₁-C₄ alkanes, into a devolatilizing extruder that reduces the chlorine content. The zeolite may comprise a catalyst of fluid catalytic cracking (FCC), a hydrophobic zeolite, a ZSM-5 zeolite or combinations. The devolatilizing extruder operates at a temperature of between 150° C. and 450° C. In the degassing step, the pressure can be from 10 torr to atmospheric, and the residence time is from 6 seconds to one hour. The extruder effluent can also be optionally treated by contact with “chlorine absorbing” compounds such as attapulgite, activated carbon, dolomite, bentonite, iron oxide, goetite, hematite, magnetite, alumina, silicon oxide and aluminosilicates, sodium oxide, calcium oxide or magnesium oxide.

The publication “HCl Formation from RDF Pyrolysis and combustion in a Spouting-Moving bed reactor”, Z. Wang, H. Li, C. Wu, Y. Chen, B. Li, Energy and Fuels, 2002, 16 608-614, discusses the efficacy of sodium and calcium to capture the chlorine emitted by high-temperature heat treatment of PVC, in particular it shows that calcium is less effective than sodium in retaining the acid that is formed.

In general, in the known art for dechlorinating chlorinated polymers, or more generally the plastic materials containing chlorine, a thermal process is mainly used wherein the treatment takes place at temperatures of at least 400° C. in the presence of sodium carbonates, oxides of calcium or calcium carbonates, iron oxides or other solid materials that capture hydrochloric acid (which is formed by thermal elimination of chlorine from the polymer), forming a stable chlorinated inorganic salt.

### SUMMARY

It would therefore be highly desirable to have available a process for treating plastic materials containing halogenated components which allows to reduce the halogen content in the final composition of plastic material, but which operates efficiently at temperatures below 400° C. to generate energy savings.

In plastic treatment processes wherein the use of dechlorinating agents consisting of metal-based salts is provided, the higher the chlorine content and the higher the concentration of stable halogenated salts which are going to be formed in the treated plastic material.

These halogenated salts, as well as the halogenated salts that derive from the alkaline earth metals originally present as fillers in the plastic material, e.g. calcium carbonate, are undesirable because they remain at the high temperatures of the refinery transformation processes of the plastic material (around such as the 400° C.) thermal/catalytic conversion processes into light hydrocarbon products for the production of monomers, thus generating fouling in the equipment downstream of the treatment.

Therefore, it would be highly desirable to have a dehalogenation process of plastics that operates efficiently even when the chlorine content, or more generally the halogens content, in the plastic material to be treated is high, i.e. a content greater than 5% by weight, generally around 6% but also up to 10% by weight with respect to the weight of the plastic material to be treated, without presenting the drawbacks that the known art complains of.

The Applicant has surprisingly found that if the plastic materials or mixtures of plastic materials, including recycled ones, especially those with a chlorine content higher than 5% by weight, are not treated according to the teachings of the present disclosure, the final composition as obtained has a high content of halogen, in particular chlorine, with repercussions on any downstream transformation processes.

The Applicant has therefore found a method to reduce the total content of halogens, more specifically at least the chlorine content, in such plastic materials, also recycled plastic materials, which contain halogenated compounds, wherein, by means of a particular treatment, a final composition of plastic material is obtained with a residual halogen content lower than the starting plastic material to be treated, wherein the final composition comprises plastic material, oligomers derived from said plastic material and halogenated salts.

The compositions of plastic material obtained after the treatment according to the present disclosure can be subsequently subjected to a conversion or hydroconversion step, preferably thermal or catalytic hydroconversion, to produce hydrocarbon products, preferably light distillates for the production of monomers or precursors of polymers, heavy distillates and gases; more preferably hydrocarbon products selected from naphtha, atmospheric diesel oil (AGO), light vacuum diesel oil (LGVO) and heavy diesel oil (HVGO), through a process chosen from visbreaking, cracking, hydrocracking, catalytic hydroconversion, catalytic hydroconversion with Eni Slurry Technology. (EST), non-catalytic hydroconversion, preferably thermal or catalytic hydroconversion as will be described in detail below.

Therefore, this patent application provides a dehalogenation process capable of treating plastic materials, or mixtures of plastic materials, including recycled ones, containing halogenated components, in order to reduce the halogen content to produce a final composition with a lower content of halogen with respect to the initial one in the plastic material, said process comprising the following steps:
heating and mixing, at the same time, or in separate stages, a plastic material, also a recycled one, containing halogenated components, and a dehalogenating agent, in one or more apparatuses that include devices for heating and mixing, bringing said composition to a temperature between 150° C. and 450° C. and maintaining the obtained composition within said temperature range for a time comprised between 10 seconds and 30 minutes, thus forming said final composition having a lower halogen content, said final composition comprising plastic material, oligomers derived from said plastic material and halogenated salts;
   said process is characterised by the fact that said dehalogenating agent contains nitrogen and is added during the process in such a quantity that the ratio between the nitrogen moles of said dehalogenating agent and the sum of the halogen moles contained in the plastic material is at least 1:1.

In said treatment process, there is also the removal of gaseous compounds containing halogen, in particular chlorine, and nitrogen which are formed in the operating conditions of mixing and heating, said removal being able to take place at the same time or in separate stages with respect to the heating and mixing.

The present treatment method is carried out in the absence of catalysts, such as, for example, depolymerisation catalysts.

In this patent application, the term “halogenated components” is intended to identify the halogen itself, or organic molecules containing halogens, or inorganic molecules containing halogens, as described below in greater detail.

In the present patent application, “dehalogenating agent” refers to a chemical compound containing nitrogen, or a mixture of chemical compounds containing nitrogen, preferably a compound, or mixture of compounds, containing ammonia nitrogen or amine nitrogen or any combination thereof.

At atmospheric pressure, said delaogenating agent decomposes at a temperature of between 30° C. and 450° C.

Furthermore, said halogenating agent, and/or optionally also one or more of the products of decomposition of said halogenating agent, is able to react with the halogens present in the plastic material, mainly forming compounds containing nitrogen and halogen, e.g., ammonium chloride, which decompose into compounds that are volatile/gaseous under process conditions.

Preferably, the decomposition of the dehalogenating agent develops ammonia.

The nitrogen-containing dehalogenating agent can be an organic or inorganic chemical compound, or a mixture of organic and/or inorganic chemical compounds containing nitrogen, especially in the forms defined above.

Preferably, said nitrogen-containing dehalogenating agent is selected from ammonia, ammonia salts, urea, amino acids or relative combinations.

Preferably, said dehalogenating agent does not contain chlorine.

Ammonia salts can be chosen from ammonium carbonate, ammonium bicarbonate, ammonium sulphate, ammonium nitrate, mono-ammonium phosphate (MAP) diammonium phosphate, anhydrous ammonium oxalate or dihydrate, ammonium alginate, ammonium carbamate, ammonium acetate, ammonium polyphosphate.

The dehalogenating agent can also be chosen from amino acids: glycine, cysteine, glutamine, asparagine, arginine, glutamine, or mixtures thereof.

According to a preferred method of the disclosure, the preferred dehalogenating compounds are ammonia and ammonia salts, more preferably ammonia salts.

In an embodiment according to the disclosure, the ammonia salts are ammonium carbonate, ammonium oxalate or mixtures thereof.

In the present patent application, “plastic material” refers to a solid composition of one or more plastics, containing halogenated components and possibly possibly further compounds of organic or inorganic origin (additives).

In the present patent application, “plastic” refers to what is defined by the IUPAC in “Terminology for biorelated polymers and applications (IUPAC Recommendations 2012)”, Pure Appl. Chem., Vol. 84, No. 2, pp. 377-410, 2012, DOI 10.1351/PAC-REC-10-12-04, term no. 89, “plastic”: polymeric materials that may contain other substances aimed at improving their properties or reducing costs”. Typically, a plastic is a polymeric material or a mixture of polymeric materials.

In the present patent application, “PLASMIX” refers to a mixture deriving from the selection of the separate collection of post-consumer plastic packaging.

In selection and sorting centres, certain polymers are first selected, especially polyethylene, polypropylene and PET (polyethylene terephthalate).

Anything that is not selected is referred to as PLASMIX. The plasmix can be of the washed type, that is, it has undergone a washing treatment to remove the wet part contained in it, or as it is, that is, unwashed.

In the present patent application, the term “halogen content in the plastic material (or in the final composition), by mass”, refers to the initial or residual halogen content determined, respectively, in the starting plastic material or in the final composition according to the determination method described herein below, wherein the residual halogen content includes both the organic halogen still present in the treated plastic material and the inorganic halogen of the halogenated salts formed during the treatment according to the disclosure.

A sample of the composition of plastic material to be tested is taken; the halogen in the sample is determined by means of ion chromatography, after combustion of the sample by means of an oxygen calorimetric bomb according to the methodology known in the art (e.g., the hydrochloric acid generated by combustion is captured by a basic sodium hydroxide solution which then is analysed with chromatography ionic).

In the present patent application, unless specifically indicated, all the quantities are expressed by weight (mass) and the percentages are percentages by weight.

In the present patent application, all the percentages by weight are calculated with respect to the total mass of the product, compound, mixture or composition described and claimed.

In the present patent application, all the operating conditions indicated in the text must be understood as preferred conditions even if not expressly stated.

For the purposes of the present disclosure, the term “comprise” or “include” also includes the term “consist of” or “essentially consisting of”.

For the purposes of the present disclosure, the definitions of the ranges always include the extremes, unless otherwise specified.

In an embodiment of the process according to the present disclosure, the ratio between the moles of nitrogen of the dehalogenating agent and the sum of the moles of halogen contained in the plastic material to be treated is between 1:1 and 4:1, even if it is understood that ratios greater than 4:1 can be used without thereby departing from the scope of the present disclosure, especially in the case of mixtures of dehalogenating agents as defined above.

In another embodiment of the process according to the present disclosure, the ratio between the moles of nitrogen of the dehalogenating agent and the sum of the moles of halogen contained in the plastic material to be treated is between 1:1 and 2:1, even if it is understood that ratios greater than 2:1 can be used without thereby departing from the scope of the present disclosure, especially in the case of mixtures of dehalogenating agents as defined above.

### BRIEF DESCRIPTION OF THE DRAWINGS

Further technical aspects of the present disclosure will be described hereinafter with particular reference to the attached FIGURE, provided purely by way of non-limiting example, which represents a preferred embodiment of the present disclosure.

FIG. 1 illustrates an embodiment of the process of the present disclosure carried out in an extrusion device which includes sections (1), (2), (3) and (4) in fluid communication with each other.

### DETAILED DESCRIPTION OF THE DISCLOSURE

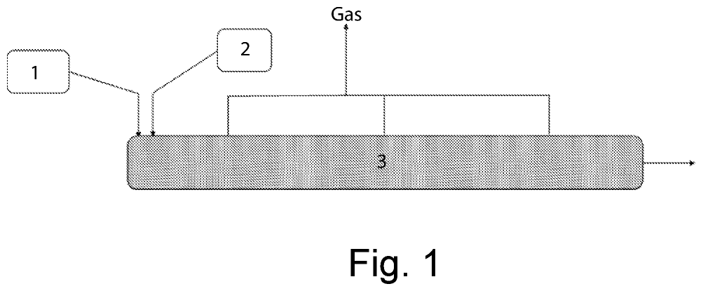

With reference to FIG. 1, section (1) represents the feeding area of the plastic material, also recycled plastic material; section (2) represents the feeding area of the dehalogenating agent (or other additives in the case of the comparison examples).

Section (3) represents the section of the extrusion device wherein it takes place
the mixing of the plastic material, including recycled material, which has been fed in section (1), with the dehalogenating agent (or with a different additive in the case of the comparative examples) added in the section (2); and
the melting of the material mixture.

In this section (3), the dehalogenation also occurs, which can be partial or complete without thereby departing from the scope of the present disclosure.

From this section (3), the gases generated by heating and by the reaction with the dehalogenating agent are removed.

The term “complete dehalogenation” is herein intended to identify the complete removal of the initial halogen content in the plastic material to be treated.

The term “partial dehalogenation” is herein intended to identify the removal of a part of the initial halogen content in the plastic material to be treated.

The dehalogenating treatment process, according to the present disclosure, allows to considerably decrease the quantity of halogen, typically chlorine, with respect to the quantity thereof initially present in the plastic material to be treated.

This ability to reduce the overall halogen content, especially chlorine, in the final composition of plastic material with respect to the plastic material to be treated, herein also defined as “dehalogenation efficiency”, can be evaluated in terms of percentage of dehalogenation, preferably of dechlorination, defining said dehalogenation percentage as the ratio per hundred between the difference in concentration of the initial halogen and the residual halogen in the composition obtained at the end of the treatment, and the initial halogen concentration, according to the following formula (wherein “conc.” is to be understood as a concentration or as a weight ratio of halogen, or halogens, with respect to the total weight of the initial plastic material or of the final composition):

$$100 \times ( Conc . Initial halogen - Conc . Residual halogen ) / Conc . Initial halogen .$$

The percentage of dehalogenation, preferably of dechlorination, which is obtained through the present dehalogenation process is higher than 50%; preferably, it is at least 54%, more preferably it is at least 60%; even more preferably it is higher than 70%, up to reach even 80-90%, but even higher.

### DETAILED DESCRIPTION

All the embodiments of the present disclosure are now described in detail, also with reference to FIG. 1.

The plastic material to be subjected to the present treatment process can comprise any composition of one or more plastics, be they virgin or recycled.

A virgin plastic can, for instance, be an off-grade plastic, a second-choice plastic or an unwanted plastic for other reasons, in part or in whole.

A recycled plastic can be, for example, a plastic waste or a plastic originating from a waste, through a recycling process.

A plastic material is said to be recycled when it also includes recycled plastic.

As mentioned, in addition to plastics, said plastic material can contain organic or inorganic compounds, such as for example metallic materials, ceramic materials, construction materials including wood, bricks, concrete; insulation materials such as glass wool and rock wool; paper and cardboard; food residues; materials from the soil such as clays, stones, compost. The plastics may also include expanded, semi-expanded or expandable foams.

Preferably, said plastic material to be treated comprises plastics for at least 60% by weight, more preferably for at least 80% by weight, even more preferably at least 90% by weight, and in particular for 100% by weight, said % being calculated with respect to the total weight of the plastic material.

Preferably said recycled plastic material is PLASMIX.

The recycled plastic material can be fed in pieces, in any form that the person skilled in the art deems appropriate to allow it to be fed to the extruder, for example in the form of agglomerates, pellets, granules, flakes, or the like and/or with dimensions suitable for such feeding.

In one embodiment, the recycled plastic material is presented as a densified one in the form of granules (e.g., with a diameter of 3-5 mm) or as agglomerates with an irregular shape or in the form of flakes.

According to a preferred method, the recycled plastic material has a median dimension (D50) greater than 0.2 cm when subjected to screening (i.e., 50% of the material is retained by a perpendicular mesh filter, having a 0.2 cm mesh) and it is preferably in densified form.

More preferably, the recycled plastic material is densified in the form of granules, flakes or other and is characterized by an apparent density greater than 50 kg/m³ measured according to ASTM D1895-17 (method C, “before loading” density measurement), preferably greater than 200 kg/m³, even more preferably greater than 300 kg/m³.

The composition of the plastics contained in said plastic material to be treated preferably comprises at least one of the following components selected from, where the percentages are expressed by weight with respect to the total of plastics (unless otherwise specified):
Polyethylene: 10-100%
Polypropylene: 0-50%
Polystyrene: 0-50%
Polyesters: 0-20%.
The sum of cellulosic, urethane and polyamide polymers: 0-20%
Inorganic fillers, such as, for example, talc and calcium carbonate: 0-30%.
Halogenated compounds in quantities such that the weight (mass) of halogens is between 0.05 and 15% with respect to the total weight (mass) of the plastic materials contained in said recycled plastic material, even more preferably between 0.1 and 10%, even more preferably between 0.2 and 8% and, even more preferably, between 0.2 and 6%.

The halogenated component can be the halogen itself, or organic molecules containing halogens, or inorganic molecules containing halogens.

Examples of organic molecules are polymers, specifically polyvinyl chloride or chloroprene; or hexabromocyclododecane; or decabromodiphenyl oxide.

Other examples of polymers are PTFE, PVF, PVDF.

Examples of inorganic molecules are magnesium chloride or titanium chloride.

The halogens present as such or contained in said molecules can be chlorine, fluorine, bromine, iodine.

Several halogenated components can be present at the same time: for example, among those mentioned in the present patent application, there combination of decabromodiphenyloxide and hexabromocyclododecane, polyvinyl chloride.

Other compounds of organic or inorganic origin may also be present in the plastic mixtures, having the function, for example, of antioxidants, thermal stabilisers, antacids, nucleating agents, UV stabilizers, antiblocking, slip agents, antislip agents, plasticisers, external lubricants, release agents, flame retardants, polymer processing aids, dyes (organic and inorganic), antistatic agents, crosslinking agents, crosslinking aids, extender oils, vulcanisation accelerators, antiozonants and mixtures thereof.

In the plastic mixtures, other organic and inorganic additives containing bromine may also be present, which are generally used to impart flame-retardant properties to the plastics, in such quantities that the bromine mass content is up to 5% of the total plastics contained in said recycled plastic material, preferably between 0.01 and 3%, even more preferably between 0.02 and 2%.

The term “polyethylene” herein refers to polymers or copolymers of ethylene, mixtures thereof; preferably chosen from high density (HDPE), polyethylene low density polyethylene (LDPE), linear low density polyethylene (LLDPE), very low density polyethylene (VLDPE), ultra low density polyethylene (ULDPE), polyethylene from metallocene catalysis (m-PE), ethylene-vinyl acetate (EVA) polymers and mixtures thereof.

The term “polypropylene” herein refers to polymers or copolymers of propylene, mixtures thereof, preferably selected from polypropylene (PP) or ethylene propylene diene monomer (EPDM) rubbers and mixtures thereof.

The term “polystyrene” refers to polymers or copolymers of styrene, mixtures thereof, preferably chosen from polystyrene (PS), expandable polystyrene (EPS), high impact polystyrene (HIPS), acrylonitrile styrene-butadiene polymers (ABS), styrene acrylonitrile copolymers (SAN), acrylonitrile ethylene styrene copolymer (AES), styrene (methyl) methacrylate copolymers (SMMA), styrene-butadiene-styrene block copolymer (SBS), styrene-ethylene-butylene-styrene block copolymer (SEBS) and mixtures thereof, and mixtures thereof with polycarbonate (PC) PC/HIPS and PC/ABS.

The term “chlorinated polymers” herein refers to polymers or copolymers of vinyl chloride or copolymers of vinylidene dichloride, mixtures thereof, preferably selected from polyvinyl chloride (PVC), polyvinyl chloride (PVDC) and its copolymers and mixtures thereof.

The term “polyesters” herein refers to polycarbonate (PC), polyethylene terephthalate (PET), polytrimethylene terephthalate (PTT), polybutylene terephthalate (PBT), poly lactic acid (PLA), poly (L-lactic acid) (PLLA), poly (D-lactic acid) (PDLA), poly (D, L-lactic acid) (PDLLA), polyhydroxyalkanoate (PHA) and mixtures thereof.

The term “polyamides” herein refers to polymers characterised by the CO—NH amide group, synthesized by condensation polymerization of a dicarboxylic acid and a diamine, or by ring-opening polymerization of a lactam. The polyamides are preferably nylon 6 (PA6), nylon 66 (PA66), nylon 46 (PA46), nylon 12 (PA12).

The urethane polymers are preferably chosen from polyurethanes (PU) containing aliphatic, or aromatic, or ester, or ether, or urea groups and mixtures thereof.

The term “cellulosic polymers” herein refers to polymers deriving from cellulose, preferably selected from cellulose nitrate, cellulose acetate, cellulose aceto-butyrate, cellulose propionate, ethyl cellulose, carboxymethyl cellulose, hydroxyethyl cellulose, benzyl cellulose and regenerated cellulose and mixtures thereof.

In the process according to the present disclosure, the aforementioned plastic materials, including recycled ones, containing halogenated components and at least one dehalogenating agent as defined above, are heated and mixed, preferably, at the same time in one or more apparatuses which include devices for heating and mixing, thus forming a composition.

This initial composition is brought to a temperature between 150° C. and 450° C., and maintained within said temperature range for a determined period of time, typically between 10 seconds and 30 minutes, thus forming a final composition.

In one embodiment, the initial composition is brought to a temperature between 200° C. and 400° C., preferably between 200° C. and 390° C., more preferably from 300° C. to 390° C.

As mentioned above, the ratio between the moles of nitrogen of the dehalogenating agent, or of the admixed dehalogenating agents, and the sum of the moles of halogen contained in the plastic material is minimum 1:1, wherein the moles of nitrogen are calculated,
if the dehalogenating agent is an ammonia salt, based on the moles of nitrogen present in the salt and the molecular weight of the salt itself;
if amino acids are used as dehalogenating agent, the nitrogen moles are calculated from the moles of the individual amino acids multiplied by the factor 0.5 for the following amino acids: glycine, cysteine, glutamic acid, glutamine. For the remaining amino acids considered, such as arginine and asparagine, the factor is 1.

The moles of each halogen are calculated by the percentage of the contained halogen divided by the molecular weight of the halogen.

In the event that the dehalogenating agent is ammonia, the moles of nitrogen are equal to the moles of ammonia.

According to a preferred method, in the described and claimed process, the dehalogenating agent is added in such quantity that:
the ratio between the moles of nitrogen and the sum of the moles of halogen contained in the plastic material is between 1:1 and 4:1; preferably between 1:1 and 2:1.

In a preferred form, the described and claimed process is carried out by extrusion, heating and mixing the starting plastic material with the dehalogenating agent, possibly also providing for the removal of the gaseous compounds containing chlorine and nitrogen that are formed (thermal separation).

As mentioned, the process described herein advantage of the present disclosure can be advantageously carried out in one or more apparatuses which include one or more devices for heating, mixing and degassing.

The term degassing refers to an equipment capable of removing (e.g. by vacuum suction) the gases or vapours that are formed by heat treatment of the mixture of plastics mixed with the dehalogenating agent.

Preferably, said apparatuses including devices for heating and/or mixing, can be chosen from amongst static mixers, dynamic mixers, stirred containers, mixing systems integrated in a heating equipment, extruders, single-screw extruders, twin-screw extruders, co-rotating twin-screw extruders, discontinuous mixers such as Banbury, Buss type piston screw mixing extruders.

Degassing equipment includes thin film distillation systems for high viscosities or extruders equipped with vacuum degassing systems.

Degassing can take place at a pressure that can vary from 10 torr (0.013 barA) to atmospheric, although it is possible to use pressures below 10 torr without thereby departing from the scope of the present disclosure.

According to a preferred method of the disclosure, in extruders it is possible to combine the rotary motion of the screws with an alternating motion of the piston type, in the direction of motion of the fluid, in order to make mixing more efficient. In the case of extruders, mixing elements of the kneading or gear type can also be used, or screw elements which remain floating with respect to the rotating body of the screw.

In the process described and claimed, the heating is controlled, i.e. the temperature of the composition is monitored and the heat input is adjusted to ensure that the temperature of the composition and/or of the apparatus, wherein said composition flows, remains in the predetermined temperature range for the predefined time as indicated.

It has in fact been found that in the temperature range defined above the halides deriving from the reaction of the nitrogen-containing dehalogenating agent with the halogen-containing plastic material pass directly, for the most part, from the solid to the gaseous state by decomposition into volatile/gaseous compounds.

Advantageously, the described and claimed process can be carried out
in a single equipment that includes means for heating, mixing and for removing the gases/vapours generated (degassing); or
in two or more separate equipment to heat, mix and remove the gases/vapours generated (degassing).

In the case of a single apparatus, it advantageously comprises an extruder equipped with at least one vacuum degassing section, preferably two degassing sections, more preferably three, even more preferably four, wherein each degassing section provides vacuum pumps, for example liquid ring and relative condensation chambers.

Preferably, the process is carried out in a system of equipment selected from
an extruder with degassing, equipped with means for the removal of the gases/vapours generated as described above, and a downstream thin film evaporator (or distillation apparatus) for high viscosities, including those of the short-path type;
a heated mixer (or heated vessel with stirrer) followed by a high viscosity thin film evaporator (or distillation apparatus), including those of the short-path type;
an extruder with degassing equipped with means for the removal of the gases/vapours generated (e.g., liquid ring vacuum pump and condensation chamber) arranged in one or more sections of the heating and mixing duct, wherein the means for the removal can be one or more in each section and arranged in series with each other.

The extruders indicated above are all suitable for this preferred embodiment.

The feeding of plastic material and dehalogenating agent to the equipment described in this patent application can be performed with any device known in the state of the art.

In addition, the plastic material and the dehalogenating agent of the disclosure can also be fed separately to said equipment.

Devices suitable for preparing the mixture between dehalogenating agents and plastic materials to be used in the present treatment process can be selected from containers with agitator which provide for a rough mixing of said components; or systems capable of preparing a fine mixture of said components. To achieve this degree of mixing, the technician skilled in the art can make changes to the mixing equipment, or modify its process parameters.

For example, if an extruder is used, the profile of the screw can be changed (for example by increasing the number of mixing elements), or by acting on the process parameters (for example, by reducing the temperature to promote an increase in viscosity and therefore an increase of mixing, or by increasing the rotation speed of the screw).

In a preferred embodiment, the final composition obtained from the treatment process of the present disclosure can be filtered.

To this end, any system known in the art for this purpose can be used, for example fixed or mobile filtering nets, and screen-changer systems that possibly implement operating methods that contemplate the in-line screen change mode without interruption of the operation or the cleaning in continuous or at intervals or when the pressure drop exceeds a certain threshold value.

In an embodiment of the disclosure, the heating step is carried out in association with one or more steps for removing the gaseous compounds containing chlorine and nitrogen, preferably by degassing, at atmospheric pressure or lower than atmospheric pressure and/or evaporation, preferably under high vacuum, e.g. absolute pressure equal to or less than 20 Torr (0.026 absolute bar), preferably less than 0.01 barA.

In this case, the gases generated are removed during heating, in particular water vapour and CO₂, as well as light organic compounds, non-condensable compounds and other decomposition compounds including those deriving from the formed halogenated salt containing nitrogen, which can be removed in the form of vapours.

In a preferred embodiment of the disclosure, there is no use of catalysts, specifically neither as a fixed component included in the equipment, for example, fixed on the walls of the equipment, nor as a component of the fed composition.

In fact, the treatment process according to the present disclosure works even in the absence of a catalyst and the catalytic processes are generally more complex to manage and more expensive.

In the case of using extruders, this removal of the generated gases can be achieved by providing at least one opening in the barrel of the extruder so that the vapours are removed from said opening, but not the treated composition that is transported by the screw. The pressure at the opening point is selected so as to allow the removal of gases, that is, it can be atmospheric or lower than atmospheric pressure.

In one embodiment, the process according to the disclosure is carried out in an extruder with a degassing system, downstream of which a further degassing with a higher degree of vacuum is provided, possibly under heating, for example by using one or more molecular thin film evaporators for high viscosity fluids, operating under a vacuum degree higher than the that of the degassers associated with the extruder, e.g. at pressures equal to or lower than 20 Torr (0.026 absolute bar), preferably lower than 0.01 barA, so as to further lower the halogen content in the final composition.

The transformation process of the plastic material obtained with the present dehalogenation process can be carried out in separate production sites with respect to the plant that carries out this dehalogenation process, even geographically separate and therefore in plants not connected to the dehalogenation plant.

In fact, the final composition obtained from the dehalogenation process in accordance with the disclosure is easily transportable, even if it can solidify if temperature is not maintained.

In this case, it may be necessary to melt said final composition in order to feed it. Any method known in the art can be used for this purpose.

The final composition obtainable from the dehalogenation process according to the present disclosure is typically a composition comprising
plastic material with a lower halogen content than the starting plastic material,
oligomers derived from the plastic contained in said plastic material,
halogenated salts.

The oligomers derived from said plastic material are to be understood according to the IUPAC Gold Book definition.

Said oligomers typically have a molecular weight comprised between 100 and 10 kDa.

Furthermore, the oligomers deriving from said plastic material are, by mass, at least three times higher than the quantity by mass of oligomers already present as impurities in the plastics of which the plastic material is composed.

The oligomers deriving from said plastic material are the oligomers generated by the thermal degradation of said plastic material.

Halogenated salts include halogenated salts of metals, mainly alkali metals of group IA and/or alkaline earth metals of group IIA, known as halogenated salts, deriving from the reaction of the metal compounds present in the starting plastic material with the halogens developed during the heating of the plastic material. Examples of such halogenated salts can be:
chlorides of alkali metals of group IA, e.g. NaCl, chlorides of the alkaline earth metals of group IIA;
fluorides of alkali metals of group IA, fluorides of alkaline earth metals of group IIA;
bromides of alkali metals of group IA, bromides of alkaline earth metals of group IIA;
iodides of the alkali metals of group IA and iodides of the alkaline earth metals of group IIA.

Furthermore, the aforementioned halogenated salts of the final may possibly also include composition halogenated salts containing one or more nitrogen atoms, such as for example, resulting from the reaction of the halogen contained in the plastic material with the nitrogen-containing dehalogenating agent.

Examples of said nitrogen-containing halogenated salts which may be present in the final composition are
compounds containing nitrogen and chlorine;
compounds containing nitrogen and fluorine;
compounds containing nitrogen and bromine;
compounds containing nitrogen and iodine, or combinations thereof.

The presence of these salts can be detected through SEM and XRD analysis.

In practice, the Applicant has found that it is possible to use one or more chemical compounds containing nitrogen as defined above, in particular ammonia nitrogen or amine nitrogen or any combination thereof, as a dehalogenating agent for plastic materials or mixtures of plastic materials, also recycled ones, containing halogenated components in the heat treatments without catalysts.

One of the advantages of the present disclosure is represented by the fact that the present process for the dehalogenating treatment of plastic material is effective in removing halogens even at relatively low temperatures (300° C.): this allows to better preserve the plastic portion from thermal degradation, in addition to energy savings.

Another advantage lies in the fact that thanks to the use of the specific dehalogenating agent as defined above, it is possible to obtain halogenated salts, preferably chlorinated salts, which can be decomposed and removed in gaseous form together with other gases during the degassing, instead of remaining as solid/ash in the dehalogenated plastic product as it happens instead in the case of inerting agents or other types of dehalogenating agents used in the art.

This entails a further advantage, namely that of being able to treat a plastic material having a high quantity of halogens, i.e. around 6% by weight, but also up to 10% by weight, while the known processes that use alkali metal salts such as dehalogenating agents are less suitable for said starting plastic material because with such a quantity of halogens in the starting plastic material they would produce a quantity of metal halides, in the form of a solid, which is not very acceptable for the subsequent process of transformation of the final composition.

A further advantage of the disclosure is that the chlorine that can be removed in the gas phase during degassing is preferably greater than 60% by weight with respect to the total chlorine in the supply stream.

Another advantage lies in the fact that the present dehalogenation treatment process does not require the use of catalysts. As mentioned above, the plastic material treated with the present process, or the final composition described above, can be sent to a refinery process of transformation into hydrocarbons such as that described, for example, in patent application WO2020/129020 in the name of the Applicants, the content of which is incorporated herein by reference.

Specifically, this dechlorinated plastic material obtained in accordance with the present disclosure can be subjected to a catalytic hydroconversion process such as the one called Eni Slurry Technology which includes the following steps:
Mixing said dechlorinated plastic material with a hydrocarbon, preferably a heavy distillate, more preferably a distillation residue, even more preferably a vacuum residue, possibly pre-heated, forming a reagent mixture;
Feed to a hydroconversion section in the slurry phase the reagent mixture, a precursor of the catalyst containing Molybdenum, and a stream containing hydrogen and carry out a hydroconversion reaction producing a reaction effluent;
Separate the reaction effluent in at least one high pressure and high temperature separator in a vapour phase and a slurry phase;
Successively send the separated vapour phase to a gas treatment section with the function of separating a liquid fraction from the gas containing hydrogen and hydrocarbon gases having from 1 to 4 carbon atoms; said liquid fraction comprising naphtha, atmospheric gas oil (AGO), vacuum gas oil (VGO);
Successively send the slurry phase to a separation section which has the function of separating the fractions of Vacuum Diesel (VGO), Heavy Vacuum Diesel (HVGO), Light Vacuum Diesel (LVGO), Atmospheric Diesel (AGO), from a stream of heavy organic products which contains asphaltenes, unconverted filler, catalyst and solid formed during the hydroconversion reaction;
Recirculate a part of said heavy organic products to the hydroconversion section, or mix them with the feed before being fed to the hydroconversion, and form a purge current with the remainder.

Preferably, the feed to the Eni Slurry Technology (EST) process is the final composition obtained with the dehalogenation process for the treatment of plastic materials described and claimed in the present patent application.

In said EST process the catalytic hydroconversion reaction and the separation of the reaction effluents at high pressure and temperature take place in a temperature range of between 420° C. and 440° C., at a pressure of between 155 atm and 160 atm.

The hydroconversion process of final inert mixtures has an efficiency, defined as the mass fraction of light distillates produced with respect to the mass of plastic material and vacuum residue fed in the plastic material treatment process, equal to at least 5%, preferably from 10 to 70%, even more preferably from 20 to 50%.

Some illustrative and non-limiting examples of the present disclosure follow.

### EXAMPLES

### Materials, Equipment and Methods of Analysis

Composition of the plastic material to be treated
(% w/w)
65% polyolefin,
5% polyamide,
14% shockproof polystyrene,
6% polyethylene terephthalate,
2% polyvinyl chloride (plus other materials in less quantity)
1.14% chlorine, calculated as the weight of chlorine (as atom) which was measured with respect to the total weight of the recycled plastic material;
2% calcium, deriving mainly from the fillers used in the plastic, generally calcium carbonate, calculated as the weight of calcium (as atom), measured via inductively coupled plasma (ICP) according to known methodology after incineration and mineralization of the sample, compared with the total weight of the recycled plastic material.
The recycled plastic material is selected to remove inert material such as stones and large metal materials, densified in the form of granules with a diameter of 3-5 mm.
Neutralising additive
“Light Sodium Carbonate” (sodium carbonate powder) with D50 equal to 0.063 mm.
Dechlorinating additive
Ammonium carbonate, ammonium oxalate, both from Sigma Aldrich (ammonium carbonate RPE ACS reagent with Cl<5 ppm and NH3>30% by weight; ammonium oxalate RPE ACS reagent>99% with Cl<2 ppm).
Determination of the chlorine content in the plastic material by mass and the percentage of dechlorination
Chlorine was determined by ion chromatography using an ion chromatograph (Dionex ICS-2100), after combustion of the plastic sample by Parr Instrument company oxygen calorimetric bomb (model 6200).
Chlorine_{Initial} is defined as the amount of total chlorine determined, in accordance with the aforementioned determination method, on the sample of plastic material entering the extruder and Chlorine_{Residual} is defined as the amount of total chlorine determined, in accordance with the aforementioned determination method, on the sample of the final composition leaving the extruder and/or leaving the high vacuum equipment. The dechlorination percentage was calculated on the basis of the ratio, by hundred, between the difference in concentration of the Chlorineᵢₙᵢₜᵢₐₗ and Chlorine_{residual}, and the concentration of the Chlorineᵢₙᵢₜᵢₐₗ according to the following formula:

100×(Chlorineᵢₙᵢₜᵢₐₗ−Chlorine_{residual})/Chlorineᵢₙᵢₜᵢₐₗ
For simplicity, the dechlorination % in the examples has been approximated to the upper or lower integer according to the conventional rounding rules.
Extruder
Co-rotating twin screw extruder, equipped with a hopper, a gravimetric screw feeder (weight loss feeder) suitable for loading solids, in flow control. The extruder is heated through resistances placed in the cylinder (barrel) and cooled with a water circuit. The extruder is operated so that the speed (screw revolutions) is adjusted in such a way that the flow rate is higher than the flow rate of the feeders in order to avoid accumulation of material in the hopper and consequent poor control of the homogeneity of the feed.
D=30 mm (Screw diameter)
L/D=76 (Characteristic length of 76 diameters)
Screw rotation speed=900 RPM.
The extruder has a barrel temperature profile divided into various distinct areas as follows:
   in the first area of section (3) of FIG. 1—which is responsible for transporting recycled plastic material and any additives in the feed (characteristic length of 4 diameters)—the temperature is set at 50° C.;
   in the second area of section (3) of FIG. 1—which has the aim of melting recycled plastic material (characteristic length of 4 diameters)—the temperature is set at 250° C.;
   in the third area of section (3) in FIG. 1
which is responsible for the dehalogenation of the recycled plastic material (characteristic length of 68 diameters)—the temperature is set at 390° C., with the exception of the ultimate 4 diameters of the section which are dedicated to cooling the mixture and which are operated by setting a barrel temperature of 200° C. This third area of the section (3) of the extruder of FIG. 1 is also equipped with three degassing zones for the removal of the gases generated, mostly carbon dioxide (CO₂) and water vapour (H₂O) and also of the ammonium chloride and/or its decomposition products, and is operated at a pressure of 0.2 bara (150 Torr) by means of a dedicated vacuum pump. The degassing points of this section are inserted at 16, 24, 32 diameters from the beginning of the dehalogenation area.

### Comparative Examples 1 and 2

Two comparative tests were carried out under the process conditions reported in Table 1.

The recycled plastic material described above was fed in the form of granules, having the dimensions defined above, to the hopper and dosing unit of the co-rotating twin-screw extruder, arranged in the section (1) (FIG. 1).

The neutralising additive (sodium carbonate) used only in the comparative example 2 was also fed to the same hopper through a screw feeder arranged in the section (2) (FIG. 1) where the additives are fed.

In section (3) of the extruder dedicated to the fusion, dehalogenation and degassing of any volatile compounds generated, both the recycled plastic material and any additives were fed through the dedicated feeders. In these samples, the only halogen detected was chlorine.

TABLE 1
COMPARATIVE EXAMPLES 1 and 2 @ 390° C.

| | EXAMPLE 1 | EXAMPLE 2 |
|---|---|---|
| | (comparative) | (comparative) |
| Recycled plastic material (% w/w) | 100 | 96.7 |
| Sodium carbonate (% w/w) | — | 3.3 |
| Output (flow rate) kg/h | 60 | 60 |
| Initial chlorine | 1.14% | 1.14% |
| Na/Cl (moles/moles) | — | 2 |
| Residual chlorine (ppm) | 5400 | 5400 |
| Dechlorination (% w/w) | 53 | 53 |

### Comparative Example 3

Comparative example 2 was repeated under the same operating conditions, but feeding a different recycled plastic material in terms of less PVC, the composition of which includes approximately (% w/w)
67% polyolefin,
5% polyamide,
14% shockproof polystyrene,
6% polyethylene terephthalate,
0.4% polyvinyl chloride,
2% of calcium, calculated as the weight of calcium (as atom) with respect to the total weight of the recycled plastic material
   and other materials in less quantity.

The recycled plastic material used contains 2200 ppm of chlorine, calculated as the weight of chlorine (as atom) with respect to the total weight of the recycled plastic material. The tested compositions, the process conditions and the results are summarised in

### Table 2.

TABLE 2
Sodium carbonate COMPARATIVE EXAMPLE 3 @ 390° C.

| | EXAMPLE 3 |
|---|---|
| | (comparative) |
| Recycled plastic material (% w/w) | 99.3 |
| Recycled plastic material (% w/w) | 0.7 |
| Output (Kg/h) | 60 |
| Initial chlorine (ppm) | 2200 |
| Na/Cl (moles/moles) | 2 |
| Residual chlorine (ppm) | 1028 |
| Dechlorination (% w/w) | 53 |

### Examples 4, 5 and 6

Comparative example 3 was repeated but replacing the sodium carbonate with one or more dehalogenating agents in accordance with the present disclosure (in powder form), using, for each example, different quantities in feeding to the feeder 2.

The tested compositions, the process conditions and the result are summarised in Table 3.

TABLE 3
Ammonium salts and 0.4% PVC @ 390° C.

| | EXAMPLE | EXAMPLE | EXAMPLE |
|---|---|---|---|
| | 4 | 5 | 6 |
| Recycled plastic material | 99.4 | 99.1 | 99.2 |
| (% w/w) | | | |
| Ammonium carbonate | 0.6 | — | 0.3 |
| (% w/w) | | | |
| Ammonium oxalate (% w/w) | | 0.9 | 0.5 |
| Output (Kg/h) | 60 | 60 | 60 |
| Molar ratio N/Cl | 2 | 2 | 2 |
| Initial chlorine (ppm) | 2200 | 2200 | 2200 |
| Residual chlorine (ppm) | 820 | 750 | 780 |
| Dechlorination (% w/w) | 63 | 66 | 65 |

As can be seen, the percentage of dechlorination increases as the used overall amount of dehalogenating agent increases, and it is not affected by the fact of using a single ammonium salt or a mixture of different ammonium salts.

Furthermore, by comparing the residual chlorine content of table 3 with that reported in table 2, it is observed that, with the same initial chlorine content and type of recycled plastic material, the percentage of dechlorination in the mixture obtained from the process according to the disclosure is greater than that of comparative Example 3, despite having used a similar amount 41 neutralising additive.

This greater dehalogenation efficiency by the nitrogen-containing dehalogenating compounds of the present disclosure with respect to those based on metal salts is unexpected.

### Example 7

The comparative Example 2 was repeated under the same operating conditions and using the same recycled plastic material comprising 2% polyvinyl chloride (i.e., 1.14% chlorine, calculated as the weight of atomic chlorine with respect to the total weight of the recycled plastic material) and containing 2% calcium, calculated as the weight of calcium (as atom) with respect to the total weight of the recycled plastic material.

Ammonium carbonate was used as dehalogenating agent according to the disclosure, which was fed in powder to the same hopper of the extruder, through the screw feeder arranged in the area (2) (FIG. 1) wherein the feeding of additives.

The tested composition, the process conditions and the result are summarised in Table 4.

TABLE 4
Ammonium carbonate and 2% PVC @ 390° C.

| | EXAMPLE 7 |
|---|---|
| Recycled plastic material (% w/w) | 97.0 |
| Ammonium carbonate (% w/w) | 3.0 |
| Output (Kg/h) | 60 |
| Molar ratio N/Cl | 2 |
| Initial chlorine | 1.14% |
| Residual chlorine (ppm) | 4200 |
| Dechlorination (% w/w) | 63 |

As it can be noted, with the same initial chlorine content (1.14%), in case of ammonium salts, the dechlorination percentage obtained in the outgoing mixture of Example 7 is higher than that obtained in the Comparative Example 2 reported in Table 1, despite having used a substantially equal amount of dechlorinating agent.

### Comparative Example 8

Comparative Example 2 was repeated under the same operating conditions but using a different recycled plastic material in terms of greater quantities of PVC and polystyrene, the composition of which includes approximately (% w/w)
69% polyolefin,
5% polyamide,
18% shockproof polystyrene,
6% polyethylene terephthalate,
10% polyvinyl chloride,
2% calcium, calculated as the weight of calcium (as atom) with respect to the total weight of the recycled plastic material,
   and other materials in less quantity.

The recycled plastic material contains 5.7% chlorine, calculated as the weight of chlorine (as atom) with respect to the total weight of the recycled plastic material.

The recycled plastic material has been selected to remove inert material such as stones and large metal materials, densified in the form of granules with a diameter of 3-5 mm.

Comparative example 8 was also conducted by increasing the flow rate of the additive (sodium carbonate) fed with respect to the flow rate of the recycled plastic material.

The tested composition, the process conditions and the result are summarised in Table 5.

TABLE 5
Sodium Carbonate and 10% PVC @ 390° C.

| | EXAMPLE 8 |
|---|---|
| | comparative |
| Recycled plastic material (% w/w) | 85.4 |
| Sodium Carbonate (% w/w) | 14.6 |
| Output (Kg/h) | 60 |
| Initial chlorine | 5.7% |
| Na/Cl (moles/moles) | 2 |
| Residual chlorine (ppm) | 28500 |
| Dechlorination (% w/w) | 50 |

### Example 9

The example was conducted by repeating comparative example 8 but using ammonium carbonate in accordance with the disclosure, instead of sodium carbonate.

The tested composition, the process conditions and the result are summarised in Table 6.

TABLE 6
Ammonium carbonate and 10% PVC @ 390° C.

| | EXAMPLE 9 |
|---|---|
| Recycled plastic material (% w/w) | 86.6 |
| Ammonium carbonate (% w/w) | 13.4 |
| Output (Kg/h) | 60 |
| Molar ratio N/Cl | 2 |
| Initial chlorine | 5.7% |
| Residual chlorine (ppm) | 21100 |
| Dechlorination (% w/w) | 63 |

From the comparison of the data of Example 9 with those of comparative example 8 (Table 5), it is observed that, with the same input PVC (equal to 10% corresponding to 5.7% of Chlorine), in case of use of ammonium, there is a higher dechlorination percentage in the mixture leaving the process according to the disclosure with respect to that of the mixture treated by adding sodium carbonate, even though a lower quantity of dehalogenating agent has been used.

### Example 10

The example was conducted by repeating example 5 in the same conditions but at an operating temperature lower than the third area dedicated to the dehalogenation of the recycled plastic material.

The set temperature is 300° C. instead of 390° C.

The tested composition, the process conditions and the result are summarised in Table 7.

TABLE 7
Ammonium oxalate and 0.4% PVC @ 300° C.

| | EXAMPLE 10 |
|---|---|
| Recycled plastic material (% w/w) | 99.1 |
| Ammonium oxalate (% w/w) | 0.9 |
| Output (Kg/h) | 60 |
| Molar ratio N/Cl | 2 |
| Initial chlorine (ppm) | 2200 |
| Residual chlorine (ppm) | 1020 |
| Dechlorination (% w/w) | 54 |

Although using a lower temperature, the use of ammonium salts resulted in obtaining a mixture of plastic material with a percentage of dechlorination comparable to that of comparative example 3 (see Table 2) wherein sodium carbonate was used in similar quantities.

With the same ammonium salt and its quantities, the decrease in the operating temperature of the extruder compared to example 5 resulted in a lower dechlorination percentage but still acceptable in accordance with the present disclosure.

The lower temperature of zone 3 of the extruder has the advantage of resulting in energy savings.

### Example 11

The example according to the disclosure was conducted by repeating example 4 under the same conditions, with the exception of the feed rate of the additive which was reduced so as to reduce the molar ratio between nitrogen and chlorine by 50%. The tested composition, the process conditions and the result are summarised in Table 8.

TABLE 8
Ammonium carbonate and PVC 0.4%, N:Cl = 1:1

| | EXAMPLE 11 |
|---|---|
| Recycled plastic material (% w/w) | 99.7 |
| Ammonium carbonate (% w/w) | 0.3 |
| Output (Kg/h) | 60 |
| Molar ratio N/Cl | 1 |
| Initial chlorine (ppm) | 2200 |
| Residual chlorine (ppm) | 815 |
| Dechlorination (% w/w) | 63 |

It is observed how the dechlorination percentage is comparable to that of Example 4 wherein the ammonia salt is the same but the molar ratio N:Cl is greater (equal to 2:1): this indicates that it is possible to work efficiently and effectively even with molar ratios N:Cl=1:1, with a significant reduction in the quantity of dehalogenating agent.

Furthermore, it is observed that, with the same initial chlorine, the dechlorination percentage is surprisingly higher when ammonium salts are used instead of sodium carbonate in stoichiometric excess (Comparative example 3), even without using a stoichiometric excess of ammonium salts.

### Example 12 (Comparative) and Examples 13 and 14

In order to evaluate the possibility of further removing the amount of chlorine, vacuum distillation tests were performed at lower pressures than those used in degassing mounted on the extruder, lower by about at least 1 order of magnitude.

Such high vacuum pressures are generally those present in equipment, such as, for example, molecular thin film evaporators for highly viscous liquids or more generally in equipment used for purification by means of high vacuum heating.

20 grams (approximately 20 ml of volume) of sample of dechlorinated PLASMIX material coming out of the extruder of Example 4 and 20 g of sample coming out of the extruder of Example 9 were taken and placed in a respective steel cylinder of 200 ml volume equipped with a valve head.

After that, the two cylinders were vacuum-sealed at 20 Torr through the respective valve.

Once the vacuum of 20 Torr (0.026 absolute bar) was reached, each cylinder was closed and placed in an oven at 300° C. for 1 hour.

The same operation was repeated by loading 20 grams of PLASMIX sample treated with sodium carbonate into another cylinder according to the methods of comparative example 8.

After 20 minutes, each cylinder was removed and cooled in air.

A sample of plastic material was taken from the open vessel for the analysis of residual chlorine.

In addition, the inside of the cylinder was also washed with water to solubilize all the ammonium chloride that was released (in the case of the samples of examples 4 and 9 of the disclosure).

The data obtained are shown in table 9.

TABLE 9
High-vacuum degassing

| | Example 12 | Example | Example |
|---|---|---|---|
| | (comparative) | 13 | 14 |
| Sample origin | Example 8 | Example 4 | Example 9 |
| | (comparative) | | |
| Initial chlorine | 5.7% | 2000 ppm | 5.7% |
| Chlorine after extruder (ppm) | 28500 | 820 | 21100 |
| Residual chlorine (ppm) | 28100 | 800 | 12300 |
| Dechlorination after extrusion | 50 | 59 | 63 |
| (% w/w) | | | |
| Final dechlorination (% w/w) | 51 | 60 | 78 |

With reference to the results of the tests performed so far, the use of a dehalogenating agent in accordance with the disclosure, e.g., Ammonium salts, surprisingly led to better results in terms of a higher percentage of dechlorination, even using stoichiometric dosages of the dehalogenating agent. Particularly remarkable is the result of Example 14 if compared with that of Example 12 (comparative) given the high quantity of chlorine initially present in the recycled material (5.7% with respect to the weight of the recycled plastic material): in fact in the case of use of dehalogenating agent, e.g. in the form of ammonia salts, in the presence of a high concentration of chlorine, it is possible to obtain a significant lowering of the chlorine content in the final composition of plastic material by heating and degassing under high vacuum (thermal separation), phenomenon not detected if a neutralising compound of the known art is used, such as sodium carbonate, which forms halogenated salts which, being stable at process temperatures because they have high melting points, cannot be removed/separated from the plastic material simply by decomposition and/or sublimation. Another surprising aspect is the dechlorination effectiveness of ammonium salts already at a temperature of 300° C. (Example 10).

1. A process of dehalogenation of plastic materials, or mixtures of plastic materials, including recycled ones, containing halogenated components, apt to produce a final composition with a halogen content lower than the initial halogen content in the plastic material, said process comprising the following steps:
heating and mixing at the same time, or in separate stages, in one or more apparatuses that include devices for heating and mixing, a plastic material, also recycled one, containing halogenated components and a dehalogenating agent, bringing said composition to a temperature of between 150° C. and 450° C.,
carrying out the removal, at the same time or in separate stages with respect to said heating and mixing, of gaseous compounds containing halogen, chlorine, and nitrogen, and
maintaining the composition thus obtained within said temperature range for a time comprised between 10 seconds and 30 minutes, thus forming said final composition with a lower halogen content comprising plastic material, oligomers derived from said plastic material, and halogenated salts,
whereby the dehalogenating agent contains nitrogen and is added during the process in such a quantity that the ratio between the nitrogen moles of the dehalogenating agent and the sum of the halogen moles contained in the plastic material is at least 1:1.

2. The process according to claim 1, wherein the dehalogenating agent is a chemical compound, organic or inorganic, containing nitrogen or a mixture of organic and/or inorganic chemical compounds containing nitrogen.

3. The process according to claim 1, wherein the dehalogenating agent is selected from ammonia, urea, ammonia salts, amino acids or combinations thereof.

4. The process according to claim 1, wherein the dehalogenating agent is an ammonia salt or mixtures of ammonia salts, selected from ammonium carbonate, ammonium bicarbonate, ammonium sulphate, ammonium nitrate, mono-ammonium phosphate (MAP), diammonium phosphate, ammonium oxalate anhydrous or dihydrate, ammonium alginate, ammonium carbamate, ammonium acetate, ammonium polyphosphate, ammonium acetate or mixtures thereof.

5. The process according to claim 1, wherein the dehalogenating agent is selected from the amino acids, preferably from glycine, cysteine, glutamine, asparagine, arginine, glutamine; or mixtures thereof.

6. The process according to claim 1, wherein said dehalogenating agent is ammonium carbonate, ammonium oxalate or mixtures thereof.

7. The process according to claim 1, wherein the ratio between the moles of nitrogen, introduced through the dehalogenating agent, and the sum of the moles of halogen contained in the plastic material to be treated is between 1:1 and 4:1.

8. The process according to claim 1, wherein the dehalogenation efficiency, defined as
100×(Initial Halogen Concentration−Residual Halogen Concentration)/Initial Halogen Concentration
is higher than 50%.

9. The process according to claim 1, wherein the heating and mixing operations are carried out in one or more apparatuses selected from extruders, static mixers, dynamic mixers, stirred reactors.

10. The process according to claim 1, wherein said plastic material, also recycled, is a densified material with a median dimension (D50) greater than 0.2 cm when subjected to screening (i.e. 50% of the material is retained by a filter at perpendicular meshes having a mesh of 0.2 cm).

11. The process according to claim 1, wherein the heating step is carried out in association with one or more steps for removing gaseous compounds containing chlorine and nitrogen, preferably by degassing, at atmospheric pressure or at pressures lower than atmospheric pressure and/or evaporation, preferably under vacuum at pressures equal to or lower than 20 Torr (0.026 absolute bar), preferably lower than 0.01 barA.

12. The process according to claim 1, wherein the steps of heating and mixing are carried out in an extruder, preferably equipped with a degassing system.

13. The process according to claim 12, wherein downstream of said extruder with degassing system, a further degassing is provided with a higher degree of vacuum, possibly under heating, using one or more thin film molecular evaporators for high viscosity fluids in order to lower the halogen content in the final composition.

14. The process according to claim 1, wherein said plastic material, including recycled material, comprises at least one of the following components selected from (where the percentages are expressed by weight with respect to the total of the plastics):
Polyethylene: 10-100%
Polypropylene: 0-50%
Polystyrene: 0-50%
Polyesters: 0-20%
The sum of cellulosic, urethane, and polyamide polymers: 0-20%
Inorganic fillers: 0-30%
Halogenated compounds in quantities such that the weight (mass) of halogens is between 0.05 and 15% with respect to the total weight (mass) of the plastic materials contained in said recycled plastic material.

15. Use of one or more chemical compounds containing nitrogen, preferably containing ammonia nitrogen or amine nitrogen or any combination thereof, as a dehalogenating agent of plastic materials, or mixtures of plastic materials, including recycled ones, containing halogenated components in heat treatments in the absence of catalysts, preferably in a dehalogenation process as defined in claim 1.

16. The process of thermal or catalytic hydroconversion of plastic material to produce light hydrocarbons for the production of monomers or polymer precursors, comprising the step of subjecting to hydroconversion the final compositions of plastic material obtained from the process as defined in claim 1.

17. The hydroconversion process according to claim 16, wherein the following steps are provided for:
mixing said obtained final compositions of plastic material (charge) with a hydrocarbon, preferably a heavy distillate, more preferably a distillation residue, even more preferably a vacuum residue, possibly preheated, forming a reagent mixture;
feeding to a hydroconversion section in the slurry phase said reagent mixture, a precursor of the catalyst containing Molybdenum, and a stream containing hydrogen and conducting a hydroconversion reaction to produce a reaction effluent;
separating the reaction effluent, in at least one high pressure and high temperature separator, in a vapour phase and a slurry phase;
successively sending the separated vapour phase to a gas treatment section having the function of separating a liquid fraction from the gas containing hydrogen and hydrocarbon gases having from 1 to 4 carbon atoms; said liquid fraction comprising naphtha, atmospheric gas oil (AGO), vacuum gas oil (VGO);
successively sending the slurry phase to a separation section having the function of separating the fractions of Vacuum Diesel (VGO), Heavy Vacuum Diesel (HVGO), Light Vacuum Diesel (LVGO), Atmospheric Diesel (AGO), from a stream of heavy organic products which contains asphaltenes, unconverted charge, catalyst and solid formed during the hydroconversion reaction; and
recirculating a part of said heavy organic products to the hydroconversion section, or mixing them with the charge before being fed to the hydroconversion section, while forming a purge current with the remaining part of said heavy organic products.
